(19) United States
(12) Patent Application Publication
(10) Pub. No.: US 2011/0200752 A1
(43) Pub. Date: Aug. 18, 2011

(54) Overspray Shielding Device and Method

(76) Inventors: Wolfgang Dorn, Berlin (DE); Bernd Kitzerow, Hamburg (DE); Dirk Kitzerow, Hamburg (DE); Francis-Jurjen Ladru, Berlin (DE)

(21) Appl. No.: 13/024,787

(22) Filed: Feb. 10, 2011

(30) Foreign Application Priority Data
Feb. 12, 2010 (EP) 10001470.3

(51) Int. Cl. B05D 1/32; B05C 11/00

(52) U.S. Cl. 427/282; 118/505

(57) ABSTRACT

A shielding device for shielding a root of a blade or a vane for a spray coating process of the blade or the vane is provided. The shielding device includes a removable insert having a first member with one or more projections sized to sealingly fit into corresponding one or more grooves over an exposed part of the root of the blade or the vane, a second member with one or more projections sized to sealingly fit into corresponding one or more grooves over a remaining part of the root of the blade or the vane, wherein the first member and the second member are adapted to be coupled to sealingly fit on the blade or the vane.

### CROSS REFERENCE TO RELATED APPLICATIONS

This application claims priority of European Patent Office application No. 10001470.3 EP filed Feb. 12, 2010, which is incorporated by reference herein in its entirety.

### FIELD OF INVENTION

The invention relates to a spray coating process of a blade of a turbomachine. The invention specifically relates to a shielding device and a method for shielding a root of a blade or a vane from overspray during spray coating of the blade or vane.

### BACKGROUND OF INVENTION

Generally, in a turbomachine, such as a gas turbine, each vane or blade has a root that engages with a slot in a stator or rotor hub, and an airfoil that extends radially across the flow path of the working fluid (gas). The blade or vane also includes a platform between the root and airfoil. During operation, portions of the blade or vane, such as the airfoil come in direct contact with the working fluid, which subjects these portions to elevated temperatures, thus causing damage to these portions.

Usually, a protective coating is applied on the airfoil section of the blade or vane which is exposed to the working fluid to improve their temperature resistance and/or abrasion resistance. The blade or vane is spray coated using conventional spraying techniques which can provide thick coatings over a large area at a high deposition rate. Examples of such spray coating methods include air or vacuum plasma spraying (APS) high velocity oxygen fuel spraying (HVOF), wire arc spraying and others.

In the application of spray coating on blades or vanes, areas that are not meant to be coated should be protected by constructional measures and processes that controls against overspray. Due to the spray spot size, spray material on mechanical finished surfaces is deposited. This spray material deposit is referred to as overspray. Therefore it is a common practice of using coating fixtures in conjunction with a spray coating application to facilitate covering root of blade or vane which are to be protected from overspray.

US20070110910 discloses a mounting suitable for covering the overspray area of the turbine blade. The mounting device is a box-like structure defining an inner portion with an opening to receive the turbine blade. The turbine blade is inserted into the inner portion of the mounting device such that the root portion of the turbine blade is surrounded by the inner portion. A shielding layer is arranged between a rim of the inner portion and the portion of the blade region that adjoins the blade root such that the root region is completely shielded from overspray.

### SUMMARY OF INVENTION

The object of the invention is to provide an improved shielding for a root of blade or vane of a turbomachine to be protected from overspray.

The above object is achieved by a device according to the claims and a method according to the claims.

The underlying idea of the present invention is to provide a shielding device having a removable insert, such that the removable insert is having one or more projections sized to sealingly fit into corresponding one or more grooves on the a blade or vane for protecting the root of the blade or vane from a spray deposit during spray coating of the blade or vane. The removable insert seals any gaps between the blade or vane and the shielding device, such that spray cannot enter into the shielding device and hence, doesn't get coated on the root of the blade or vane. The proposed insert can be easily removed from the shielding device, thus making the shielding device easy to use.

According to one embodiment herein, the removable insert is sized to sealingly fit circumferentially around the root of the blade or vane. This provides the flexibility of spray coating the blade or vane irrespective of any spray direction.

According to an embodiment, the removable insert is made of a silicone with a ceramic solid additive. Such insert helps to increase thermal capacity of the insert which helps the insert to withstand high temperatures while spray coating.

According to a further embodiment, the removable insert has first and second members. The first member has one or more projections sized to sealingly fit into corresponding one or more grooves over a first part of the root of the blade or vane. The second member has one or more projections sized to sealingly fit into corresponding one or more grooves over a second part of the root of the blade or vane, and the first member and the second member are adapted to be coupled to circumferentially fit on the blade or vane. Such insert can easily be circumferentially fit onto the root of the blade or vane by assembling both the members onto the root of the blade or vane and unfixes the insert by disassembling the insert from the root of the blade or vane.

According to another aspect of the present invention, a method for shielding the root of the blade or vane for a spray coating process of the blade or vane includes mounting of the removable insert onto the root of the blade or vane, such that one or more projections of the insert sealingly fits into corresponding one or more grooves on the blade or vane. This helps to sealingly cover the relevant portion on the blade root from entry of the spray coat.

### BRIEF DESCRIPTION OF THE DRAWINGS

The present invention is further described hereinafter with reference to illustrated embodiments shown in the accompanying drawings, in which:

FIG. 1 illustrates a side cross-section view of a shielding device having installed a blade or vane of a turbine with a removable insert in accordance with one embodiment.

FIG. 2 shows a front end partial internal view of the shielding device of the FIG. 1.

FIG. 3 shows a front end view of the insert in a two parted structure having a first member and a second member.

Various embodiments are described with reference to the drawings, wherein like reference numerals are used to refer to single elements throughout. In the following description, for purpose of explanation, numerous specific details are set forth in order to provide a thorough understanding of one or more embodiments. It may be evident that such embodiments may be practiced without these specific details.

The shielding device according to the present invention, may be used for protecting the root portions of blades and vanes from over spray while spray coating of the blades or vanes. Hence it should be appreciated that although the embodiments illustrated hereinafter refer particularly to a blade used in the turbine section of a turbine engine, but the present invention is equally applicable for spray coating of vanes.

Also, as used herein, a “turbomachine” refers to any rotating machinery incorporating a turbine that adds or removes mechanical power from a continuous, steadily flowing stream of fluid. A turbomachine operates through the action of rows of blades attached to a circular rotor which is mounted on a rotating shaft. Examples of turbomachines include certain kinds of compressors, as well as turbopumps, turbines, hydraulic transmission impellers and the like. In a turbine, the blades are attached to a rotor disk or hub by fitting the root of the blade into a slot in the rotor disk, thereby locking the movement of the blade from any movement.

### DETAILED DESCRIPTION OF INVENTION

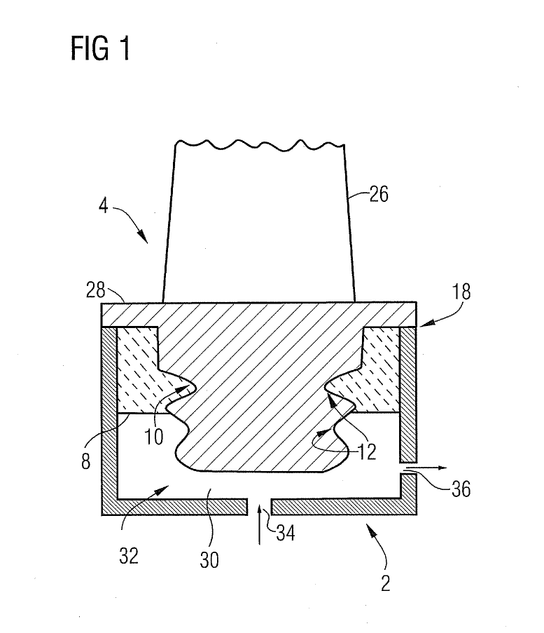

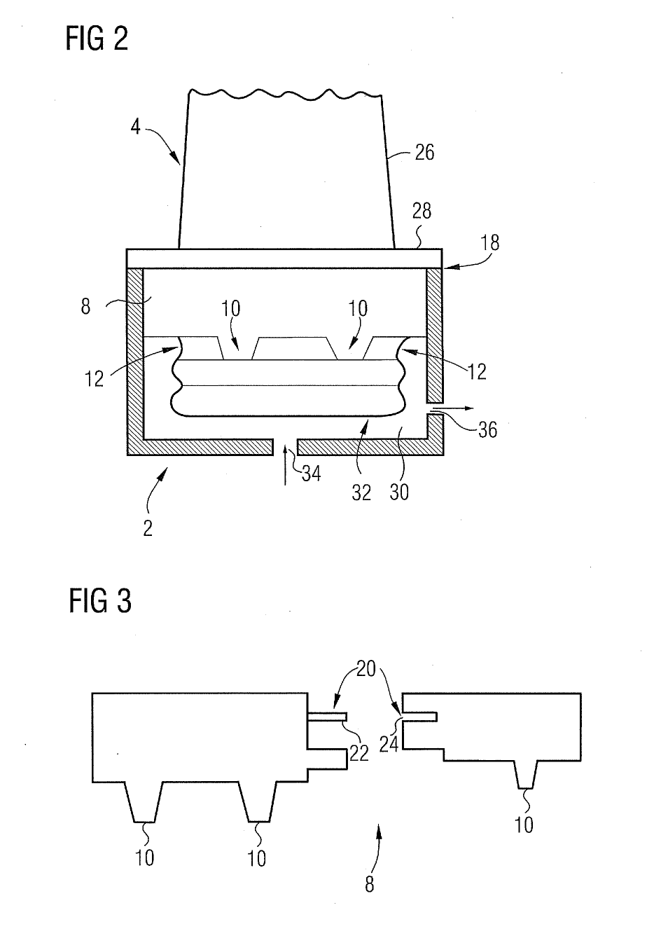

FIG. 1 illustrates a cross-section side view of a shielding device 2 installed on to a having a blade 4 of a turbine. FIG. 2 shows a front end partial internal view of the shielding device 2 of the FIG. 1.

Referring jointly to FIG. 1 and FIG. 2, the blade 4 comprises an airfoil 26, a root 6 and a platform 28 between the airfoil 26 and the root 6 which are constructed as a single piece, thereby being integral with each other. The root 6 comprises grooves 12 and is adapted to fit within a correspondingly shaped slot in the periphery of a rotor hub (not shown) with the airfoil 26 extending radially outwardly from the disk. The airfoil 26, root 6 and the platform 28 could also be separate parts which can be assembled together.

The shielding device 2 has a removable insert 8 which has projections 10 sized to sealingly fit into corresponding grooves 12 on the blade 4. In the illustrated embodiment, the insert 8 is mounted onto the root 6 by inserting the projections 10 of the insert 8 onto the corresponding grooves 12 of the root 6. This helps to sealinly cover the exposed portion on the root 6 from overspray. In one embodiment, the root 6 with the insert 8 is mounted into a first opening 18 of the device 2.

The insert 8 can be easily un-installed from the shielding device 2 and dismounted from the root 6 of the blade 4. In an alternate embodiment, the insert 8 can be installed first into the first opening 18 of the shielding device 2 and subsequently the root 6 can be placed fittingly on to the insert 8. While disassembling, the root 6 of the blade 4 can be dismounted first and than the insert 8 can be uninstalled out of the shielding device 2.

The size of the first opening 18 is selected such that the first opening 18 closely fits a volume around insert 8 with the root 6 when the insert 8 is installed into the shielding device 2. This gives a tight fitting of the root 6 within the shielding device 2. The size of the first opening 18 can vary depending upon the turbine component undergoing the coating.

In the illustrated embodiment, when the root 6 is installed into the shielding device 2, sides of the insert 8 adjoin with the first opening 18 to sealingly fit the root 6 with the insert 8. This prevents the possibility of any gaps between the root 6 and the shielding device 2, so that the leakage of spray is prevented. This further helps to safeguard the root 6 from spray cloud forming.

In one embodiment, the shielding device 2 can be used for shielding multiple blades during spray coating. Accordingly, several first openings 18 may be provided in the shielding device 2 and a plurality of inserts 8 can be installed into the shielding device 2, allowing several blade roots 6 to be simultaneously accommodated for shielding from over spray. In a further embodiment, the insert 8 can be structured in such a way that, the insert 8 can mount the plurality of roots 6 of the blades 4.

The shielding device 2 encloses a cavity 30 into which root 6 of the blade 4 is inserted vertically from above in such a way that the root 6 is located substantially within the cavity and the blade 4 extends with its airfoil 26 radially outwards from the first opening 18, wherein the airfoil 26 is subjected to the medium flowing through during the operation of the turbine provided with it outside the shielding device 2.

During the spray coating process, the cavity 30 contains a cool air 32 which helps to cool the blade 4 during the spray coating process. The cool air 32 enters into the cavity 30 from a second opening 34 of the shielding device 2. The second opening 34 is provided in such a way that it does not get closed by the insert 8 when the insert 8 is installed into the device 2. The insert 8 restricts outflow of cool air from the shielding device 2 by closing any openings between the platform and the shielding device 2. The cool air 32 flows into the cavity 30 naturally. Alternatively, the second opening 34 can also be coupled with an air pumping device which can pump in cool air into the device 2 to maintain a required air pressure inside the device 2. The blade 4 is subjected to high pressure from the cool air 32 which gets pressurized to come out of the shielding device 2 when the insert 8 is installed into the shielding device 2 and the root 6 of the blade 4 is mounted onto the insert 8 of the blade 4. A pressure of the cool air 32 inside the cavity 30 is maintained by throttling out a portion of the cool air 32 in a controlled manner through a third opening 36 of the shielding device 2. The third opening 36 is provided in such a way that it does not get closed by the insert 8 when the insert 8 is installed into the device 2. A diameter of the third opening 36 are sufficiently large to maintain pressure of the cool air 32 and throttle a portion of the cool air 32 through the third opening 36. The diameter of the third opening 36 can be varied as per the requirement of the air pressure inside the cavity 30. Alternately, a air pressure releasing apparatus can be coupled to the third opening 36 to throttle out a portion of the cool air 32 out of the device 2.

The insert 8 helps to sealingly fit the root 6 of the blade 4 with into the shielding device 2. The removable insert 8 is sized so that the root 6 of the blade 4 can be mounted circumferentially fit into insert 8. This provides the flexibility of spray coating the blade irrespective of any spray direction. Such a size of the insert 8 fits the insert 8 sealingly into the shielding device 2, so that no space is left between the shielding device 2 and the insert 8 to prevent entry of the spray. In all, when the root 6 is mounted into the shielding device 2 with the insert 8, the shielding device 2 shields any entry of the spray inside the shielding device 2 to prevent any formation of spray cloud on the root 6. The insert 8 is sized to fit circumferentially onto the shielding device 2 as well as onto the root 6 of the blade 4. The insert 8 specifically blocks any openings for the spray dust which can enter into the shielding device 2 through any of the openings remaining space between the platform 28 of the blade 4 and the shielding device 2. By fitting the insert 8 in such a way, openings for external materials, like, air, dust or any other miniature materials, etc are blocked.

The insert 8 is mounted on to the root 6 of the blade 4 by force fitting the insert 8 in such a way that the projections 10 of insert 8 gets fit on to the grooves 12 on the surface of the root 6 of the blade 4. The insert 8 is placed on a portion of the root 6 of the blade 4 where the chance of depositing the spray is expected to be more, but the insert 8 can also be placed on the root 6 to cover the whole root 6 of the blade 4.

The insert 8 is made of a resilient material which serves to function as a mechanical barrier between the coating spray and the root 6 of the blade 4. The force fitting of the insert 8 serves to increase the local stress and enables to fit thinly on the root 6 of the blade 4.

The insert 8 is arranged in such a way that it is positioned to adjoin with a region of the root 6 of the blade 4 which intersects with the platform 28 between the airfoil 26 and the root 6 of the blade 4. The positioning is done in such a way that the insert 8 fits on to the root 6 of the blade 4 such that to seal any gap between the platform 28 and the portion of the insert 8 adjoining the platform 28. This prevents the leakage of the spray through the gap onto the surface of the root 6. This also prevents leakage of environmental dust or any such material which can make dust cloud in composition with the spray.

The projections 10 are integral part of the insert 8, where the projections 10 and the insert 8 are in a single mould format. Such projections give strength to hold the root 6 of the blade 4. The projections 10 can also be additionally added to a mould of the insert 8 for increasing the strength further or for any other reason. The projections 10 can also separately be added to the mould of the insert 8. In any of such a case where projections 10 are added separately or additionally, the projections 10 can be made of material like metals or any other matter which have the high strength and good resilience behavior. Such projections 10 added additionally or separately can be further molded into the insert 8 either through process of melting the insert 8 and the projections 10 together to stick to each other permanently or such a molding can be done in any other way like wielding, or any other possible way to stick the insert 8 and the projections 10 permanently. The projections 10 can also be attached to each other in a releasable way by screwing, clamping or any other way which can make the projections 10 releasable and as well as provide strength to the insert 8 to hold the blade 4 on its root 6. Providing the projections 10 which can be attached releasable helps to customize the projections 10 as per the variability of the root 6 and the blade 4 according to the various applications and turbomachines. Thus, the projections 10 can be replaced according to the various roots of blades 4. Also, insert 8 and its projection 10 can be used interchangeably with other inserts and projections 10 to the customization needs.

The projections 10 are scaled or threaded, so that the insert 8 can hold the blade on its root 6 regularly throughout the spray coating process. The projections 10 are provided the shape, so that they can fit on the grooves 12 in a force fitting manner, i.e., the shape of the projections 10 would be in compliment to the grooves 12 of the root 6 of the blade 4.

The grooves 12 on the root 6 of the blade 4 are made to fix the blade inside the slot of the rotor. So, the insert 8 and the projections 10 should be made according to the shape of the root 6 of the blade. To hold the blade properly, the projections 10 should be of the complementary shape of the grooves 12 to form fit the projections 10 onto the grooves 12. The grooves 12 can have the threads or scales or any like surface geometry to provide the strength to the holding of the blade by the insert 8. The surface geometry of the grooves 12 can be complimentary to the surface geometry of the projections 10, so as to further increase the strength of the holding of the blade on its root 6.

The insert 8 is preferably made of a material of low thermal conductivity, such as a silicone with ceramic solid additive, for example aluminum oxide (Al₂O₃), Titanium Oxide (TiO₂), Magnesium Oxide (MgO), Zinc Oxide (ZnO₂), or any combination of any such materials, etc. Such a material is also resistant to physical deformations due to the heat used while spray coating process. Also, the insert 8 would not allow the hot air inside the air foil of the blade 4 to pass out from the shielding device 2. At the same time, these materials are of relatively less cost, and can be cleaned easily, thereby reducing the cost involved in cleaning the overspray deposit from the insert 8 for further usage. Generally, these materials are inert to the spray, or other gases, dust or other abrasive particles, which helps to protect the root 6.

The insert 8 is easily and quickly installable and removable so that the likelihood of repetitive motion injuries is reduced and the pace of coating operations can be accelerated. The insert 8 is inexpensive and has high durability which makes it possible to reuse the insert 8 for a substantial number of times.

FIG. 3 shows a front end view of the insert 8. In this example, the insert 8 is formed of two members 14 and 14. The first member 14 has one or more projections 10 sized to sealingly fit into corresponding one or more grooves 12 over a exposed part of the root 6 of the blade 4. Likewise, the second member 16 has one or more projections 10 sized to sealingly fit into corresponding one or more grooves 12 over a remaining exposed part of the root 6 of the blade 4. The first member 14 and the second member 16 are adapted to be coupled to sealingly fit on the blade 4. Such insert 8 improves the mounting of the insert 8 onto the root 6 of the blade 4.

The insert 8 is installed by mounting the first member 14 from one side of the root 6 over an exposed part of the root 6, wherein one or more projections 10 of the first member 14 sealingly fits into corresponding one or more grooves 12 on the exposed part of the root 6. Next, the second member 16 is mounted from another side of the root 6 on a remaining part of the root 6 wherein one or more projections 10 of the second member 16 sealingly fits into corresponding one or more grooves 12 on the remaining exposed part of the root 6. Finally, both the members 14, 16 are coupled together and the insert 8 is installed into an first opening 18 of the shielding device 2. The insert 8 can also be installed by firstly, coupling both the member 14, 16 together, secondly placing the insert 8 into the shielding device 2 and than finally mounting the root 6 onto the insert 8.

In one embodiment, the insert 8 can be established by coupling the first member 14 and the second member 16, than the insert 8 can be installed as per the embodiments described in FIGS. 1 and 2.

The first member 14 and the second member 16 are coupled by a connecting mechanism 20 to sealingly fit on the blade 4. Such removable insert 8 provided an easy way to mount the insert 8 onto the root 6 of the blade 4.

The connecting mechanism 20 is a mechanical plugging system having male plug 22 and corresponding female plug 24. The first member 14 is coupled to the second member 16 by inserting the male plug 22 into the female plug 24. This provides an easy way to attach and de-attach the first member 14 and the second member 16. This type of connecting mechanism 20 provides a regular contact between the two parts. The connecting mechanism 20 need not be plugs rather they can be threaded fasteners, clamps, adhesives, magnets, clips, adhesives, velcros, friction locks and the likes or the combination of any of these.

The present invention provides an efficient, rapidly and easily applicable and removable masking arrangement which is reusable. The spray which is deposited on the shielding device 2 or the insert 8 can be removed by using various processes such as using an aqueous effluent to rinse off the spray, treating with deactivation solutions or the any solvents, which cleans the surface of the insert 8 to be reused.

The insert 8 provided herein is thus durable, replaceable, minimally affecting the existing turbine disc parameters. The insert 8 is adaptable to be installed on root 6 without entailing large expenses in root alteration.

1.-10. (canceled)

11. A shielding device for shielding a root of a blade or a vane of a turbomachine from overspray during spray coating of the blade or the vane, comprising:
a removable insert including a projection,
wherein the removable insert is sized to sealingly fit into a corresponding groove on the root of the blade or the vane.

12. The shielding device according to claim 11,
wherein the removable insert is further sized to fit circumferentially around the root of the blade or the vane.

13. The shielding device according to claim 11, wherein the removable insert comprises a silicone with a ceramic solid additive.

14. The shielding device according to claim 11,
wherein the removable insert further comprises a first member including a first projection sized to sealingly fit into a corresponding first groove over a first part of the root of the blade or the vane and a second member including a second projection sized to sealingly fit into a corresponding second groove over a second part of the root of the blade or the vane, and
wherein the first member and the second member are adapted to be coupled to circumferentially fit on the blade or the vane.

15. The shielding device according to claim 11, wherein the insert is installed into a first opening of the shielding device and subsequently the root is placed fittingly onto the insert.

16. The shielding device according to claim 15, wherein a size of the first opening is selected so that the first opening fits a volume around the insert with the root when the insert is installed into the shielding device.

17. The shielding device according to claim 11, wherein a second opening allows cool air to enter through the shielding device in order to cool the blade or vane.

18. A method for shielding a root of a blade or a vane from overspray during spray coating of the blade or the vane, comprising:
mounting a removable insert onto the root of the blade or the vane,
wherein a projection of the insert sealingly fits into corresponding a groove on the blade or the vane.

19. The method according to claim 18, further comprising:
installing the insert with the root of the blade or the vane into a shielding device by placing the insert with the root into a first opening of the shielding device.

20. The method according to claim 18, further comprising:
installing the insert into a shielding device by placing the insert into the first opening of the shielding device and subsequently mounting the removable insert onto the root of the blade or the vane.

21. The method according to claim 18, wherein the removable insert is established by coupling a first member of the removable insert and a second member of the removable insert.

22. The method according to claim 18,
wherein the mounting of the removable insert further comprises:
mounting a first member of the removable insert over a first part of the root of the blade or the vane, wherein one or more projections of the first member sealingly fits into corresponding one or more grooves on the first part of the root; and
mounting a second member of the removable insert over a second part of the root of the blade or the vane, wherein one or more projections of the second member sealingly fits into corresponding one or more grooves on the second part of the root; and
coupling the first member and the second member to sealingly fit on the blade or the vane.

23. The method according to claim 18, wherein the removable insert is further sized to fit circumferentially around the root of the blade or the vane.
